(19) United States
(12) Patent Application Publication
(10) Pub. No.: US 2007/0288840 A1
(43) Pub. Date: Dec. 13, 2007

(54) SYSTEM AND METHOD FOR PARSING LARGE XML DOCUMENTS TRANSPORTED ACROSS NETWORKS AS XML ENCAPSULATED CHUNKS

(76) Inventors: DAVID ANDREW GIRLE, PHOENIX, AZ (US); ASHOK CHERIAN MAMMEN, BANGALORE (IN)

Correspondence Address: IBM CORP (YA);C/O YEE & ASSOCIATES PC, P.O. BOX 802333, DALLAS, TX, 75380, US

(21) Appl. No.: 11/423,715

(22) Filed: Jun. 13, 2006

(51) Int. Cl. G06F 17/00

(52) U.S. Cl. 715/513

(57) ABSTRACT

A computer implemented method, data processing system, and computer program product for parsing large extensible markup language (XML) documents transported across networks as XML encapsulated chunks. When a plurality of XML chunks comprising an XML document is received, a payload of a first chunk in the plurality of XML chunks is parsed. Responsive to determining that the payload of the first chunk contains an unmatched event tag, retaining the unprocessed bytes of data associated with the unmatched event tag. The payload of a second chunk in the plurality of XML chunks is then parsed, wherein the unprocessed bytes retained are parsed as a first part of the payload of the second chunk, and wherein the payload of the first chunk and the payload of the second chunk are parsed using a single invocation of a payload parser.

### BACKGROUND OF THE INVENTION

1. Field of the Invention

The present invention relates generally to an improved data processing system, and in particular, to a computer implemented method, data processing system, and computer program product for parsing large Extensible Markup Language (XML) documents transported across networks as a sequence of chunks in multiple encapsulating XML documents.

2. Description of the Related Art

XML is a character-based markup language that is designed for annotating data with semantic information that can be parsed by a computer. XML is used to provide a standardized syntax for information exchange between software processes. With the widespread adoption of XML as an information exchange mechanism on the Internet, it is becoming common to exchange large XML documents between servers and clients. The XML document must be serialized or converted from an in-memory representation to a serial representation that can be sent to another device.

A large XML document may be easily exchanged over a network that allows the entire document to be sent as one packet from one device to another. However, when an XML document is sent over a constrained network (e.g., a cellular communications network), the entire document cannot be sent as one packet. This situation may occur in any communications scenario, such as when sending large documents over a cellular carrier network or performing inter-computer serialization. When the large XML document is sent over such a constrained network, the originating XML document is often split into multiple packages or chunks in order to fit within the network constraints on packet size. For example, a cellular network provider may impose a size limitation of 50 kb on packages sent over the network. If the originating document size is 1 MB, the document may be broken up into multiple, small 50 kb or less packets. With existing parsing techniques, when the multiple packets arrive at the receiving device, the XML document is reassembled from the packets into a memory buffer, and the reassembled document is then parsed. Thus, the receiving device is required to maintain a buffer which is at least the size of the XML document, which can be problematic for resource-constrained, embedded devices (e.g., cell phones).

Another problem with traditional parsing techniques is the parsing of XML packets encoded, embedded, and transported within an encapsulating XML envelope. An XML document comprises an envelope, which includes information such as address, authentication, and checksum information represented in an XML structure, and the payload, which comprises the content of the XML document. The XML document contains a single logical element, referred to as the root element, having zero or more child elements. Each element is defined with a pair of tags. For example, an open tag begins with “<” and closes with “>”, and a close tag starts with “</” and closes with “>”. In XML, there is a concept of well-formedness, meaning for every opening tag you need the appropriate close tag, and the tags must be perfectly nested. When an XML document is split into multiple XML packets, the packets encapsulated in the XML envelope cannot be well-formed since the packets will contain incomplete pairings of open and closetags. As a result, the incomplete pairings render the packets unsuitable for traditional parsing.

Current methods for parsing encapsulated packets employ existing XML parsers that require a continuous stream of XML data or a complete XML document. One such method implements a data stream that is aware of the message protocol. This message stream must be able to process a sequence of packets, process and strip away the XML envelope, and pass the body (carrying the payload) up to the XML parser. However, this method is not reusable and may not be feasible for all messaging protocols. This method may also be a problem when the XML document contains nested envelopes. A second method employs two processes connected by a pipe. The first process parses incoming packets, parses and strips away the envelope, and pushes the body data into one end of the pipe. In the second process, the XML parser executes and continuously reads data from the other end of the pipe, and blocks when there is no data in the pipe. This second method is simple but inefficient since it requires two processes and some form of inter-process communication. In addition, there is no guarantee that the body will be consumed immediately, leading to the buffering of the body data and possible flooding of the pipe.

### SUMMARY OF THE INVENTION

A computer implemented method, data processing system, and computer program product is provided for parsing large extensible markup language (XML) documents transported across networks as XML encapsulated chunks. When a plurality of XML chunks comprising an XML document is received, a payload of a first chunk in the plurality of XML chunks is parsed. Responsive to determining that the payload of the first chunk contains an unmatched event tag, retaining the unprocessed bytes of data associated with the unmatched event tag. The payload of a second chunk in the plurality of XML chunks is then parsed, wherein the unprocessed bytes retained are parsed as a first part of the payload of the second chunk, and wherein the payload of the first chunk and the payload of the second chunk are parsed using a single invocation of a payload parser.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which illustrative embodiments may be implemented;

FIG. 2 is a block diagram of a data processing system in which illustrative embodiments may be implemented;

FIG. 3 is a block diagram illustrating exemplary components with which illustrative embodiments may be implemented;

FIG. 4 is a sequence diagram illustrating a stateful XML parsing technique; and

FIG. 5 is a flowchart of a process for parsing large XML documents transported across networks as XML encapsulated chunks.

### DETAILED DESCRIPTION OF THE PREFERRED EMBODIMENT

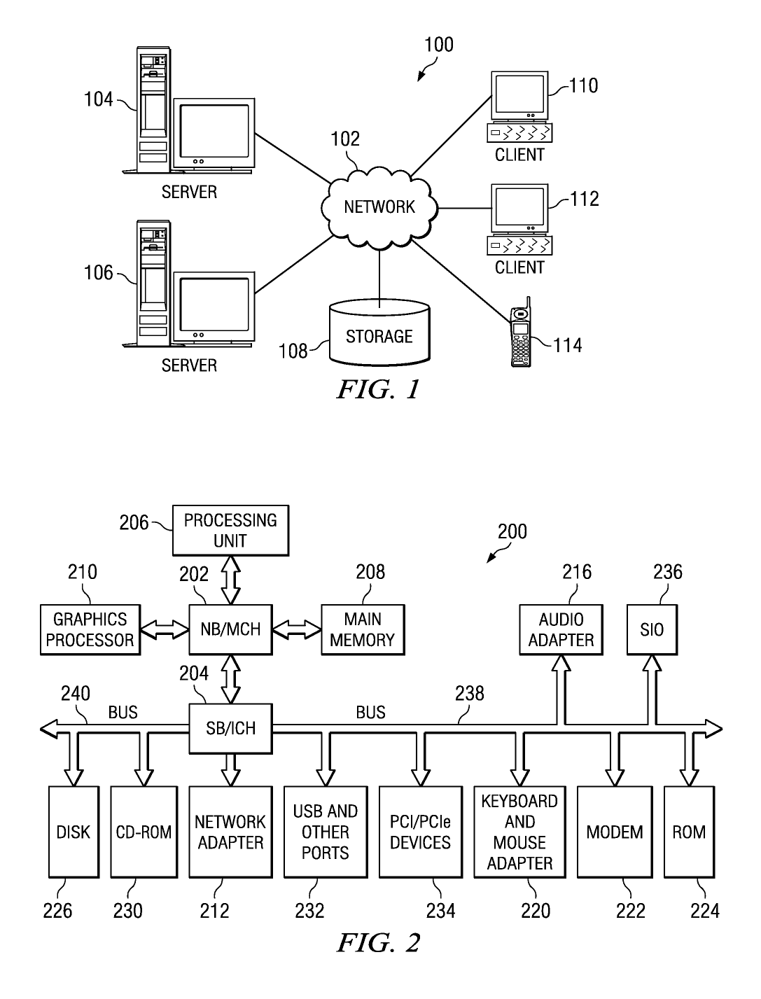

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which the illustrative embodiments may be implemented. Many modifications to the depicted environments may be made without departing from the spirit and scope of the illustrative embodiments.

With reference now to the figures, FIG. 1 depicts a pictorial representation of a network of data processing systems in which illustrative embodiments may be implemented. Network data processing system 100 is a network of computers in which illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers, cellphones, PDAs, other memory/CPU constrained devices or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), cellular network, or a wide area network (WAN). FIG. 1 is intended as an example, and not as an architectural limitation for different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes for the illustrative embodiments may be located.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Illustrative embodiments provide for a computer implemented method, apparatus, and computer usable program code for compiling source code. The illustrative embodiments may be performed in a data processing system, such as data processing system 100 shown in FIG. 1 or data processing system 200 shown in FIG. 2.

Illustrative embodiments provide a method for sending large, arbitrary-sized documents over constrained, serialization mechanisms (e.g., over a cellular network). In particular, the illustrative embodiments provide a solution to the buffering and well-formedness problems in the current art by revising traditional XML parser techniques to allow for retaining state information across parse invocations. A parser is a software or hardware module that analyzes a text stream and breaks the text into constituent parts. The parser reads in an XML document and generates selected events depending on the tags encountered in the XML document. The recent introduction of new parsing technology utilizing simple application programming interfaces (APIs) has allowed for parsers to become increasingly standardized. An example of such standard parsing technology is Simple API for XML (SAX), which is a Java-based API. In traditional SAX parsing techniques, a new parser is instantiated for each document to be parsed. Consequently, a receiving device is required to buffer all payloads to produce a single, well-formed document that may be traditionally parsed. Problems may arise when the payload of a message to be parsed is one part of a larger document that was split to conform to network constraints. As the payload will contain incomplete pairings of open and closetags, the SAX parser at the receiving device will throw a well-formedness exception when processing the packet.

The XML parsing technique described in the illustrative embodiments allows for extending standard APIs such as SAX and traditional parsing techniques so that the payload parser retains state information across parse invocations and is appropriate in a communications scenario. The state information retained is the remaining, unprocessed bytes in the last payload. For example, a large XML document is split into four sequential packets or chunks (A, B, C, and D) and sent to a receiving device. As the document segmentation is based on message size, rather than payload schema, a document tag “<aDocumentTag>” may be split between two sequential messages as “<aDo” and “cumentTag>”. When processing packet A, the payload parser in the receiving device will retain the remaining bytes of data after the last tag that could be handled. When the payload parser begins to process packet B, the parser will first process the remaining bytes retained from packet A, and then process packet B. Thus, the remaining bytes from previously processed packet A comprise the retained state information as the parser moves from packet A to packet B. The parser may retain the remaining bytes in a packet through various implementations, including having the parser issue a request to the device sending the data stream to redeliver the remaining bytes, and having the parser buffer the remaining bytes. The remaining bytes may be buffered in the parser, since typically the size of the content retained is very small.

In addition to enabling the exchange of large XML documents in constrained communications networks such as a cellular network, the illustrative embodiments allow for exchanging large messages between constrained devices. For example, a cellular phone may comprise a memory card (e.g., SD card) and internal memory. Although the amount of memory available on the memory card is large, the amount of internal memory of the cellular phone is very constrained. As a result, an XML payload often needs to be delivered not to the memory of the cellular phone, but rather to the storage of the memory card. The illustrative embodiments enable one to stream the XML content out to the storage (memory card) of the cellular phone. In this manner, the illustrative embodiments are applicable not only when large documents are sent between devices over constrained networks, but also where the target device itself is a constrained device.

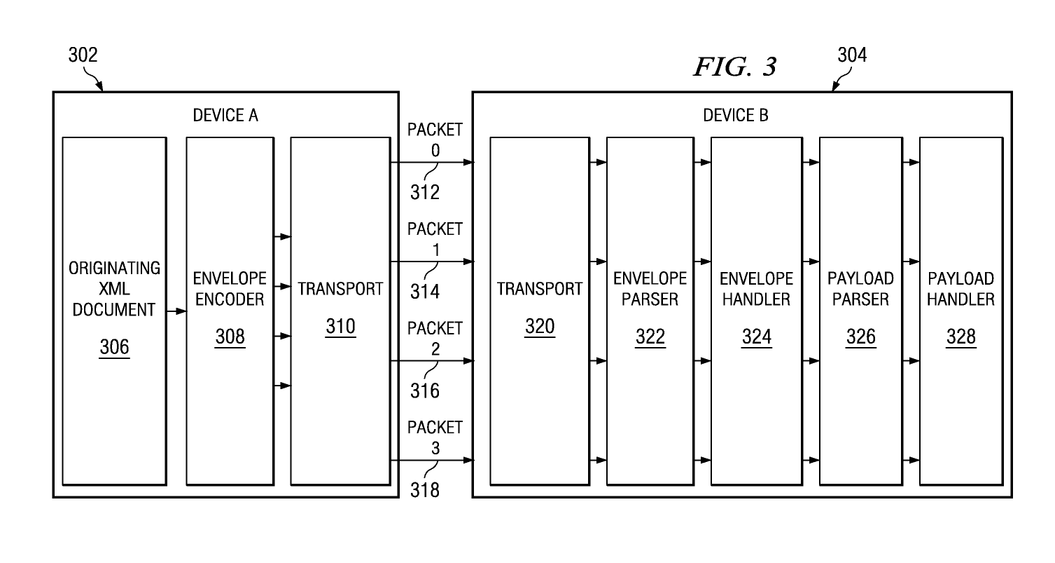

FIG. 3 is a block diagram illustrating exemplary components with which illustrative embodiments for parsing large XML documents transported across networks as chunks in multiple encapsulating XML documents may be implemented. In this illustrative example, a message is exchanged between device A 302 and device B 304. The message itself is an XML document, such as originating XML document 306, with an envelope and body, the body carrying the message payload (the XML file). An example of a simple XML document that may be transported from device A 302 to device 304 B is shown below:

<html>
<head><title>My Story</title></head>
<body>
<p>The quick brown fox jumped over the lazy dog.</p>
</body>
</html>

Each message sent on the transport is of the form:

<eav><hdr> . . . message id . . . </hdr><bdy> . . . payload . . . </bdy><env>

When constraints on message size are imposed by the network or device, the XML document must be packetized without regard to schema or well-formedness concerns. For instance, if a restriction is placed on the message such that the message cannot be longer than 80 characters total (i.e., the total length of message header, payload and footer must be less than 80 characters), the message payload is required to be less than 46 characters in the above example, because of the size of the header and footer. In this illustrative example, originating XML document 306 at device A 302 is provided to Envelope Encoder 308. Envelope Encoder 308 splits the document into multiple smaller packets which conform to the size constraints imposed by the limitations of the network or by the limitations of the receiving device itself, and the packets are then provided to Transport 310. Transport 310 then provides the packets (e.g., packet 0 312, packet 1 314, packet 2 316, and packet 3 318) to device B 304. The content of an example packetization of originating XML document 306 into packets 0-3 312-318 is shown below:

1 2 3 4 5 6 7 8
12345678901234567890123456789012345678901234567890123456789012345678901234567890
<env><hdr>0</hdr><bdy>&lt;html&gL;&lt;head&gt;&lt;title&gt;My </bdy></env>
<env><hdr>1</hdr><bdy>Story&lt;/title&gt;&lt;/head&gt;&lt;body&gt;</bdy></env>
<env><hdr>2</hdr><bdy>&lt;p&gt;The quick brown fox jumped over the</bdy></env>
<env><hdr>3</hdr><bdy> lazy dog.&lt;/p&gt;&lt;/body&gt;&lt;/html&gt;</bdy></env>

### As shown, the special characters in the XML packets have been escaped as entity references to ensure the packets comprise valid XML characters.

Device B 304 is shown to comprise Transport 320, Envelope parser 322, Envelope handler 324, Payload parser 326, and Payload handler 328. As each message or packet is received by device B 304, Transport 320 extracts the message from the transport protocol. Envelope parser 322 pulls the message from Transport 320 and strips off the envelope and reads in each packet. If Envelope parser 322 encounters tags within the content, the parser generates envelope events based on the tags. Examples of tags that may generate events include every open and close tag pair. Each event is effectively self-contained, and downstream componentry may handle the events as they are generated. For instance, Envelope parser 322 pushes the generated envelope events to Envelope handler 324, which is used to interpret the envelope events. Envelope handler 324 then pushes the payload or XML body to Payload parser 326.

Payload parser 326 may comprise a standard parser, such as Simple API for XML (SAX). However, Payload parser 326 is modified to support multiple invocations and to maintain state between invocations. As a result, the multiple chunks which makeup the payload from a large message may be individually sent to the payload parser, and the SAX events may be generated as expected. Payload parser 326 reads the payload or XML body to generate self-contained events based on the tags contained in the payload. These self-contained payload events are pushed to Payload handler 328, which interprets the events, as each event is generated. Payload parser 326 also determines if there are remaining bytes of data in the payload from which an event cannot be generated. For example, since events may be generated at an opening tag and a closing tag, the payload parser may determine whether a close tag in an open and closetag pair is missing in the payload. For each open tag read in the payload, a paired closing tag must also be read in order for the parser to be able to throw an event (otherwise, the software is essentially “blocked”). If the parser reads an open tag and several bytes of data follow, but there is no close tag paired with the open tag, the payload parser determines that the several bytes of data following the open tag actually “belong” in the next package. To retain the state information across parser invocations, Payload parser 326 reads the open tag and the several bytes of data in the package and stores the tag and data in memory in the parser. When the next sequential packet is to be parsed, the same Payload parser 326 is used to process the next packet. Payload parser 326 first processes the remaining bytes from the previous packet that are retained in the parser memory, and then the parser processes the payload in the new packet. In this manner, the payload event that could not be generated by the parser when reading the previous packet since the packet did not contain the close tag may now be generated by the same parser since the parser retained the state information needed to fire the event across the packets.

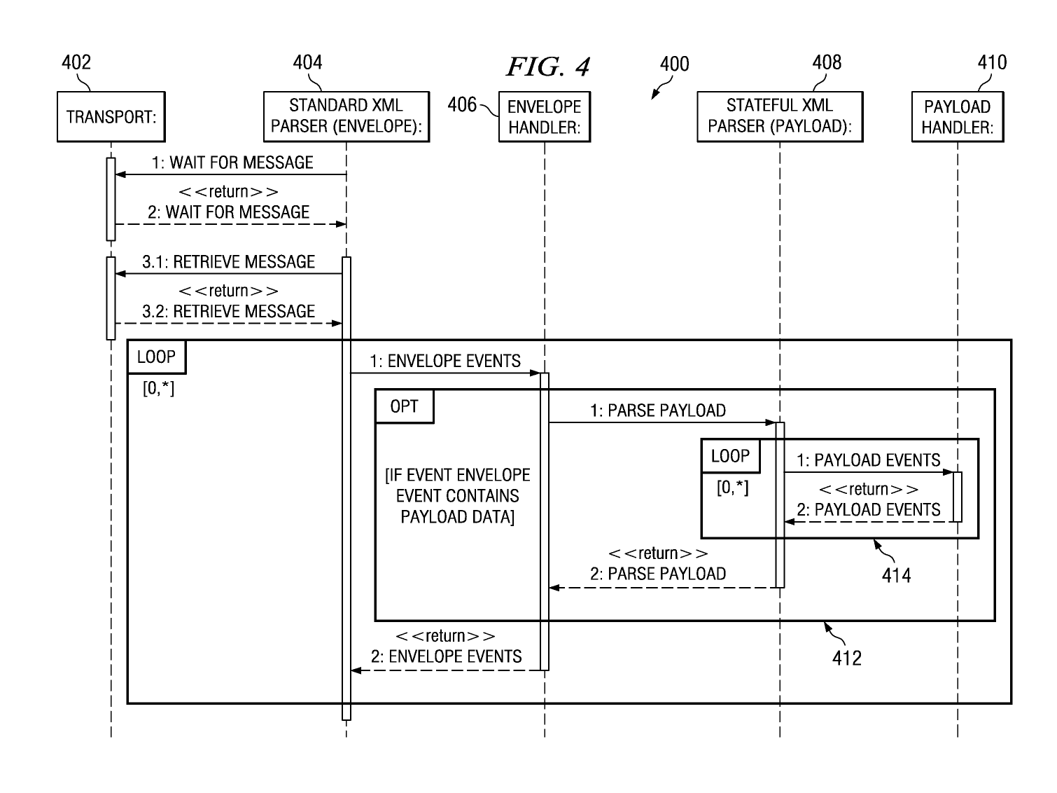

Turning next to FIG. 4, a sequence diagram illustrating the stateful XML parsing technique is shown. Sequence diagram 400 illustrates the sequence of parsing logic performed by a receiving device, such as receiving device B 304 in FIG. 3. Sequence diagram 400 comprises classifiers Transport 402, Standard XML Envelope parser 404, Envelope handler 406, Stateful XML Payload parser 408, and Payload handler 410.

Standard XML Envelope parser 404 waits for a message from Transport 402. When a message is received by Transport 402, Transport 402 sends a returns control to Standard XML Envelope parser 404. Standard XML Envelope parser 404 then retrieves the message from the Transport 402, and parses the message by removing the envelope. Standard XML Envelope parser 404 reads the message and generates events based on the tags in the message. Standard XML Envelope parser 404 provides the generated events to Envelope handler 406.

Frame 412 illustrates an optional step that may be performed when the event envelope contains payload data. If the event envelope contains payload data, Envelope handler 406 parses the payload and sends the payload to Stateful XML Payload parser 408. Looping logic 414 illustrates how one Stateful XML Payload parser 408 may be used to process multiple packets of a single XML document. If the size of the originating message conforms to size restrictions imposed by the network or receiving device, the message received by Transport 402 may comprise a complete XML document. If the originating message does not fit within the size constraints imposed, the received message may comprise one chunk or packet of the originating XML message. In this situation, a single instance of Stateful XML Payload parser 408 is used to parse the payload data of each packet comprising the originating XML document. Stateful XML Payload parser 408 generates payload events, provides the events to Payload handler 410, and loops to process the next packet by generating payload events contained in the next packet and providing those events to Payload handler 410. Stateful XML Payload parser 408 is able to process multiple packets by retaining state information between invocations, such that data that did not generate an event in a preceding packet is retained and processed first when the subsequent packet is handled.

Consider the particular example of a modified SAX parser. A Standard SAX parser by definition will only parse complete XML documents, the parse method may be invoked only once for a particular XML document and will not return until parsing is complete (see http://www.saxproject.org/apidoc/org/xml/sax/XMLReader.html #parse(org.xml.sax.InputSource). The method definition may be modified to allow the parse method to be called multiple times, with different InputSources, for the same XML document. A reset method will also need to be provided to allow the same SAX parser instance to be reused for parsing other XML documents.

Using the stateful parsing technique shown in the illustrative embodiments, one instance of the modified SAX parser may be used to handle all four packets by allowing the stateful parsing technique to repeatedly call the method parse. The modified SAX parser uses the retained state information to parse the remaining data in one packet when a subsequent packet is parsed. Thus, allowing the payload parser to repeatedly call a parsing method solves the problem of having to create buffers at least as large as the originating document to be parsed. It also allows each chunk (represented by different InputSources) to be parsed without requiring that the chunk be well-formed, as long as they are present within the complete XML payload of the originating document. In addition, the originating XML document does not need to be reassembled at the receiving device before parsing the document. Instead, the packets comprising the originating document may be provided to the parser to generate events immediately.

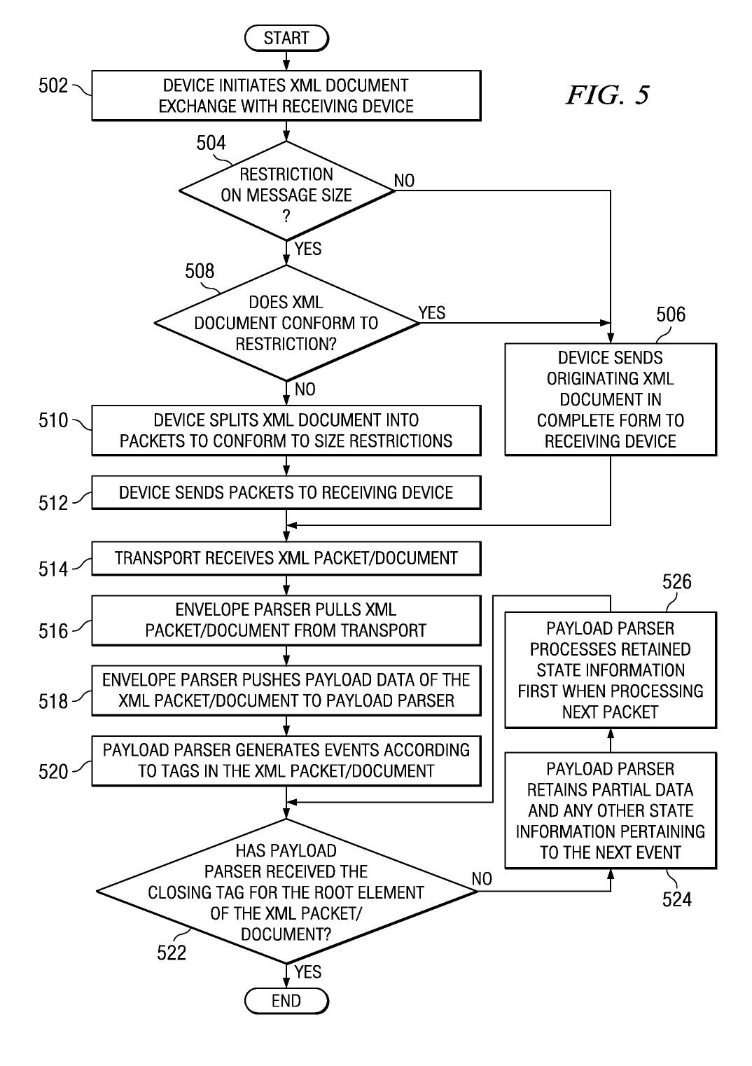

FIG. 5 is a flowchart of a process for parsing large XML documents transported across networks as XML encapsulated chunks. The process begins with a device initiating an exchange of XML data to a receiving device (step 502). A determination is made by the device as to whether the communications network or the receiving device imposes a restriction on the size of messages sent to the receiving device (step 504). If no restriction is present, the device sends the originating XML document in its complete form to the receiving device (step 506). If a restriction is present, the device determines whether the size of the XML document conforms to the imposed data packet size restriction (step 508). If the size of the XML document conforms to the size restriction imposed, the device sends the originating XML message in its complete form to the receiving device (step 506). If the size of the XML document is larger than the allowable data packet size, the device splits the XML document into two or more chunks or packets to conform to the size restrictions imposed (step 510). The device then sends the packets to the receiving device (step 512).

When an XML document (including the original XML document or a packet of the original XML document) is received by the transport in the receiving device (step 514), the envelope parser in the receiving device pulls the document from the transport and parses the document by generating envelope events and pushing the events to the envelope handler (step 516). The envelope handler processes the envelope events and, if the event envelope contains payload data, pushes the payload data of the document to the stateful payload parser (step 518). The payload parser generates payload events according to the tags in the payload (step 520).

When parsing the payload data of an XML document, the payload parser determines whether it has received the closing tag for the root element of the large originating XML document (step 522). If the closing tag for the root element has been received, the process terminates thereafter. If the closing tag for the root element has not been received, any partial data pertaining to the next event, and any other state information, is retained (step 524). The same invocation of the payload parser used to process the previous packet is used to process the next sequential packet of the originating XML document. When the payload parser begins to process the next sequential packet, the payload parser first processes the state information retained from the previous packet, and then processes the payload data in the next packet (step 526). The process returns to step 522 and is repeated until all of the packets of the originating XML document are parsed and no unprocessed bytes exist.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for parsing an extensible markup language document as a plurality of extensible markup language chunks, the computer implemented method comprising:
responsive to receiving a plurality of extensible markup language chunks comprising an extensible markup language document, parsing a payload of a first chunk in the plurality of extensible markup language chunks;
responsive to a determination that the payload of the first chunk contains an unmatched event tag, retaining bytes of data associated with the unmatched event tag; and
parsing a payload of a second chunk in the plurality of extensible markup language chunks, wherein the bytes retained are parsed as a first part of the payload of the second chunk, and wherein the payload of the first chunk and the payload of the second chunk are parsed using a single invocation of a payload parser.

2. The computer implemented method of claim 1, further comprising:
repeating the retaining step and second parsing step for each chunk in the plurality of extensible markup language chunks until a closing tag for the unmatched event tag is received.

3. The computer implemented method of claim 1, wherein the first parsing step and second parsing step include generating payload events when event tags are encountered in the payload of the first chunk and the payload of the second chunk.

4. The computer implemented method of claim 1, wherein the bytes of data comprise bytes of data following a last well-formed event tag in the payload.

5. The computer implemented method of claim 1, wherein the first parsing step, the retaining step, and the second parsing step are performed by a payload parser.

6. The computer implemented method of claim 1, wherein the bytes of data are retained in a memory of the payload parser.

7. The computer implemented method of claim 1, wherein the bytes of data are retained by issuing a request to a device sending the plurality of extensible markup language chunks to redeliver the bytes of data.

8. A data processing system for parsing an extensible markup language document as a plurality of extensible markup language chunks, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to parse a payload of a first chunk in a plurality of extensible markup language chunks in response to receiving the plurality of extensible markup language chunks comprising an extensible markup language document, retain bytes of data associated with an unmatched event tag in response to determining that the payload of the first chunk contains an unmatched event tag, and parse a payload of a second chunk in the plurality of extensible markup language chunks, wherein the bytes retained are parsed as a first part of the payload of the second chunk, and wherein the payload of the first chunk and the payload of the second chunk are parsed using a single invocation of a payload parser.

9. The data processing system of claim 8, wherein the processing unit further executes the computer usable code to repeat retaining the bytes and parsing the bytes until a closing tag for the unmatched event tag is received.

10. The data processing system of claim 8, wherein the computer usable code for parsing the payload of the first chunk and parsing the payload of the second chunk includes computer usable code for generating payload events when event tags are encountered in the payload of the first chunk and the payload of the second chunk.

11. The data processing system of claim 8, wherein the bytes of data comprise bytes of data following a last well-formed event tag in the payload.

12. The data processing system of claim 8, wherein the bytes of data are retained in a memory of the payload parser.

13. The data processing system of claim 8, wherein the bytes of data are retained by issuing a request to a device sending the plurality of extensible markup language chunks to redeliver the bytes of data.

14. A computer program product for parsing an extensible markup language document as a plurality of extensible markup language chunks, the computer program product comprising:
a computer usable medium having computer usable program code tangibly embodied thereon, the computer usable program code comprising:
computer usable program code for parsing a payload of a first chunk in a plurality of extensible markup language chunks in response to receiving the plurality of extensible markup language chunks comprising an extensible markup language document;
computer usable program code for retaining bytes of data associated with an unmatched event tag in response to determining that the payload of the first chunk contains an unmatched event tag; and
computer usable program code for parsing a payload of a second chunk in the plurality of extensible markup language chunks, wherein the bytes retained are parsed as a first part of the payload of the second chunk, and wherein the parsing of the payload of the first chunk and the parsing of the payload of the second chunk are performed using a single invocation of a payload parser.

15. The computer program product of claim 14, further comprising:
computer usable program code for repeating retaining the bytes and parsing the bytes for each chunk in the plurality of extensible markup language chunks until no unprocessed bytes are found.

16. The computer program product of claim 14, wherein the computer usable program code for parsing the payload of the first chunk and parsing the payload of the second chunk includes generating payload events when event tags are encountered in the payload of the first chunk and the payload of the second chunk.

17. The computer program product of claim 14, wherein the unprocessed bytes comprise bytes of data following a last well-formed event tag in the payload.

18. The computer program product of claim 14, wherein the computer usable program code for parsing the payload of the first chunk, retaining the bytes, and parsing the payload of the second chunk is executed by a payload parser.

19. The computer program product of claim 14, wherein the bytes are of data retained in a memory of the payload parser.

20. The computer program product of claim 14, wherein the bytes of data are retained by issuing a request to a device sending the plurality of extensible markup language chunks to redeliver the remaining bytes of data.
